(19) United States
(12) Patent Application Publication
(10) Pub. No.: US 2005/0230929 A1
(43) Pub. Date: Oct. 20, 2005

(54) Fastening structure for a scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/827,269

(22) Filed: Apr. 20, 2004

(51) Int. Cl. B62M 1/00

(52) U.S. Cl. 280/87.05

(57) ABSTRACT

A fastening structure for a scooter is coupled with a front strut and a board. The front strut comprises a pair of pipes for insertion into a pair of pipes of the board. Both the pipes of the front strut and the board comprise through holes corresponding to each other. The fastening structure includes a latch, an elastic element, and a barrel. The latch has a ring secured at the center portion thereof. The elastic element sleeves onto the latch which then inserts into the barrel with the ring sliding within the barrel. One end of the latch is formed with a knob while the other end is formed with a round corner. The elastic element has its two ends engaging with one end of the barrel and the ring, respectively. The latch inserts from one end into the barrel and protrudes a portion from another end of the barrel and into the holes of the pipes of the front fork and the board to secure the front strut and the board.

### FIELD OF THE INVENTION

This invention relates to a fastening structure for a scooter, and more particularly to a fastening structure to facilitate assembly and disassembly of the scooter.

### BACKGROUND OF THE INVENTION

A scooter currently on the market is to connect a board to a front handle at the front end. The board has wheels secured underneath the board. The front handle is also secured with a wheel underneath. The scooter has a fastening device for connection of the front handle and the board, so that a user can stand on the board to operate the scooter with hands holding the front handle to maintain a steady status. The board may be disengaged from the front handle and operated separately. However, the connection of the front handle and the board requires bolts and nuts which require tools to fasten or to loose. This design requires too many tools and it takes hours of labor.

In view of this, the inventor has derived the present invention to improve the shortcomings.

### SUMMARY OF THE INVENTION

It is the primary object of the present invention to provide a fastening structure for a scooter, which is easy to assemble and disassemble.

It is another object of the present invention to provide a fastening structure for a scooter, which is secure.

It is a further object of the present invention to provide a fastening structure for a scooter, which uses less manpower and is cost effectiveness.

### BRIEF DESCRIPTION OF THE INVENTION

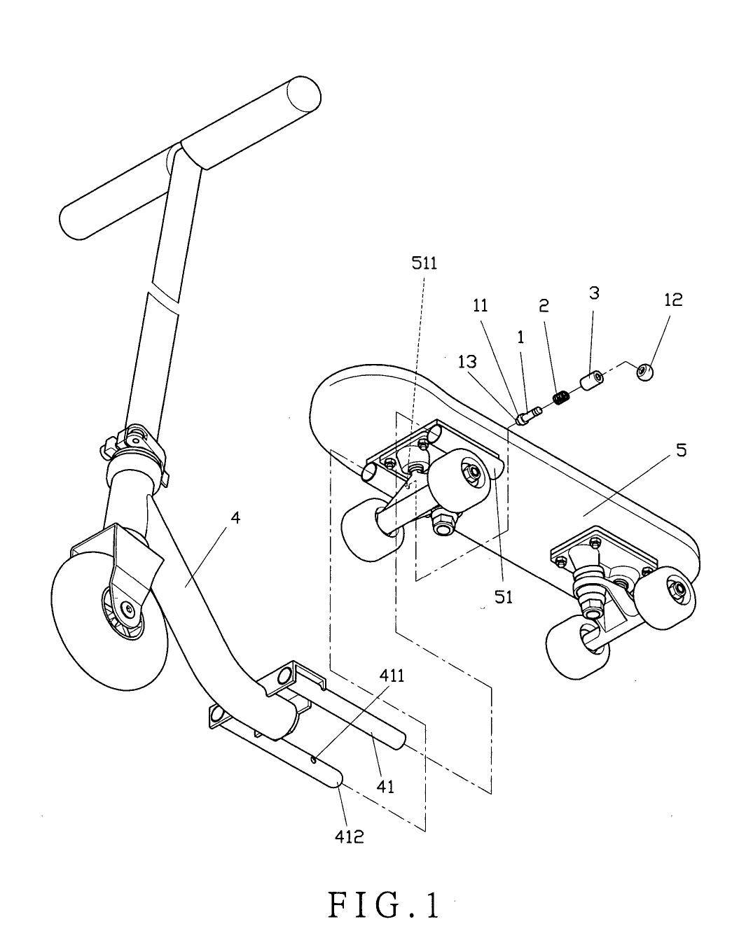

FIG. 1 is an exploded view of the present invention;

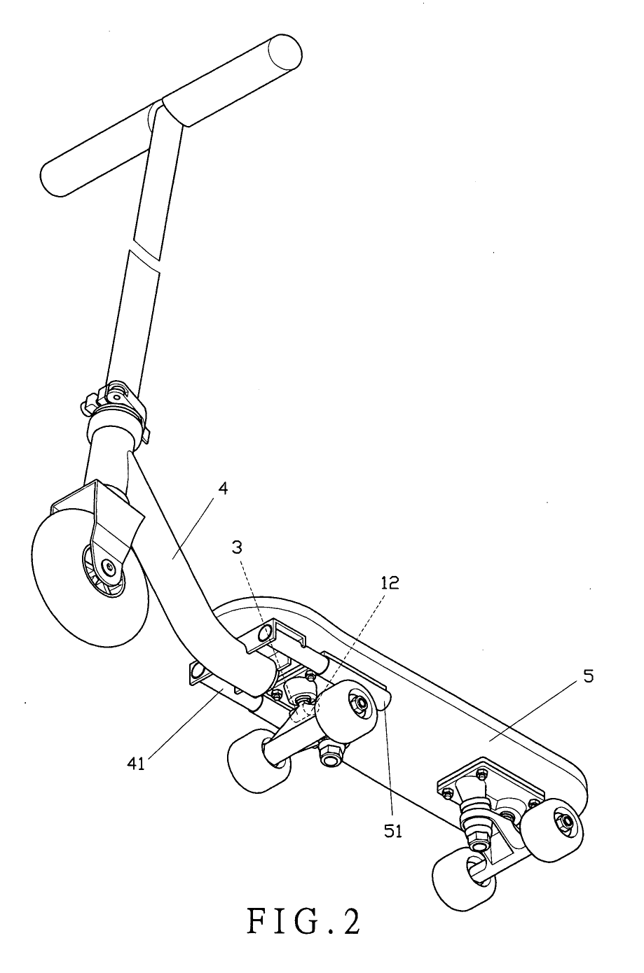

FIG. 2 is a perspective view of the present invention;

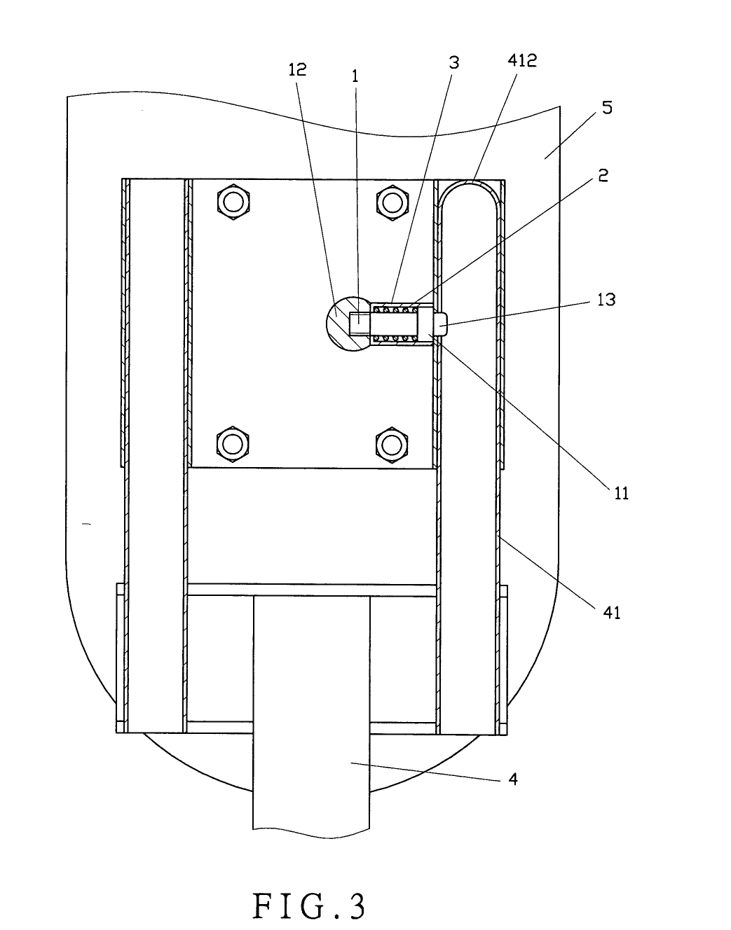

FIG. 3 is an enlarged bottom view of FIG. 2 showing a locked position, partially sectioned;

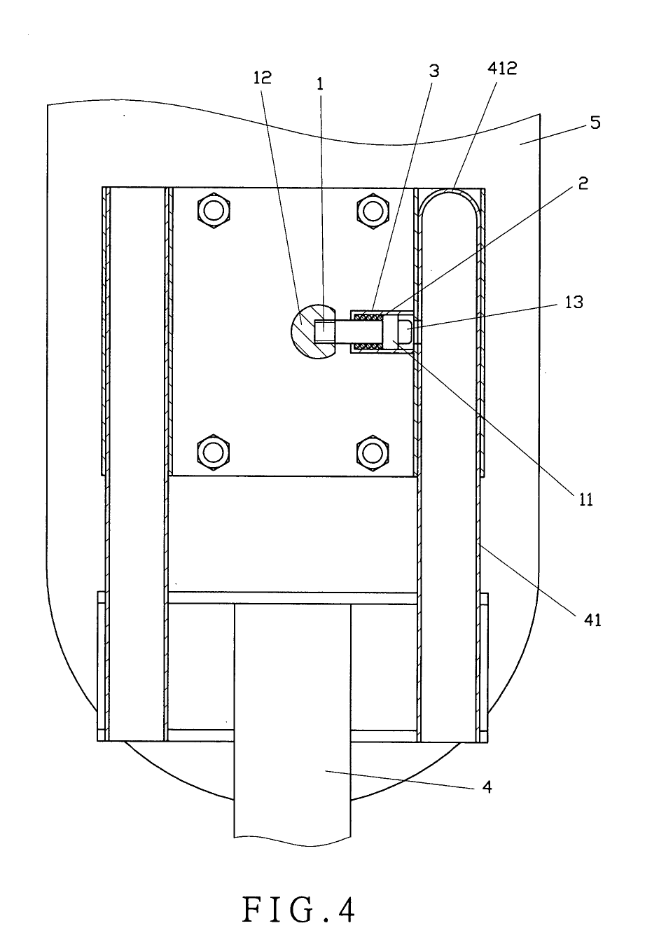

FIG. 4 is view similar to FIG. 3 showing an unlocked position; and

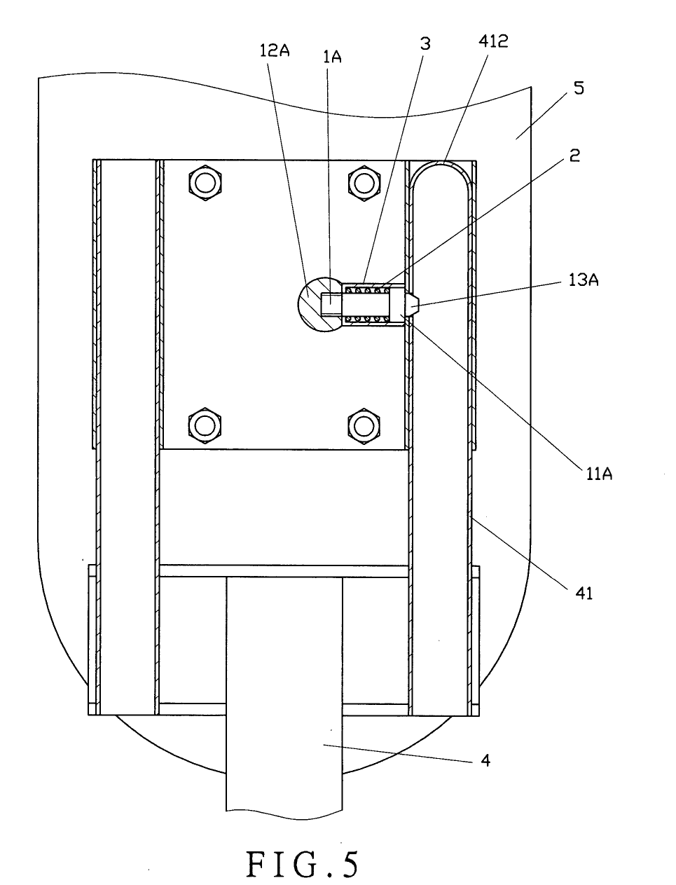

FIG. 5 is an enlarged bottom view of a second embodiment of the present invention.

### DETAILED DESCRIPTION OF THE PREFERRED EMBODIMENT

As shown in FIGS. 1 and 2, the present invention is coupled with a front strut 4 having a pair of pipes 41 at rear ends, and a board 5 having a pair of pipes 51 to be connected with the pipes 41 of the front strut 4. Both the pipes 41 and 51 comprise through holes 411 and 511 corresponding to each other.

The present invention comprises a latch 1, an elastic element 2, and a barrel 3. The latch1 1 is secured with a ring 11 at the middle portion. As shown in FIG. 3, the elastic element 2 sleeves onto the latch 1 which then inserts through the barrel 3 with the ring 11 in the barrel 3. The latch 1 has one end formed with a knob 12 while the other end is formed with a round corner 13. The elastic element 2 has its two ends engaging with one end of the barrel 3 and the ring 11, respectively. The round corner 13 of the latch 1 is constantly sticking out of the barrel 3 and inserting into the hole 511 of the pipe 51 of the board 5. The round corner 13 continuously protrudes into the hole 411 of the pipe 41 of the front strut 4 to secure the front strut 4 and the board 5 together.

To disassemble the present invention, as shown in FIG. 4, the knob 12 of the latch 1 is pulled backward, which brings the round corner 13 to detach from the holes 411 and 511. Thus, the pipes 41 of the front strut 4 may be pulled away from the pipes 51 of the board 5. The board 5 may be used as a skateboard, and also for storage and carrying purposes.

To assemble the present invention, the pipes 41 of the front strut 4 are slid into the pipes 51 of the board 5. One round end 413 of the pipe 41 will urge the round corner 13 of the latch 11 to retreat from the hole 51 of the board 5 until the pipes 41 insert into the pipes 51 where the holes 41 aligning with the holes 51. The round corner 13 of the latch 11 will be urged by the elastic element 2 to protrude into the holes 41 and 51 to secure the front strut 4 to the board 5.

FIG. 5 shows another embodiment of the present invention. A latch 1A is secured with a ring 11A at the middle portion. A knob 12A is formed at one end of the latch 1A, and a slanting surface 13A is formed at the opposite end thereof. The slating surface 13A functions as the round corner 13 of the latch 1.

1. A fastening structure for a scooter being coupled with a front strut having a pair of pipes and a board having a pair of pipes, said pipes of said front strut and said pipes of said board comprising holes corresponding to each other, and characterized in that:
said fastening structure comprising a latch, an elastic element, and a barrel, said latch having a ring secured at a center portion thereof, said elastic element sleeveing onto said latch, said latch inserting through said barrel with said ring in said barrel, said latch having one end formed with a knob while another other end formed with a round corner, said elastic element having its two ends engaging with one end of said barrel and said ring, respectively, said latch inserting from one end into said barrel and protruding a portion from another end of said barrel and into said holes of said pipes of said front fork and said board to secure said front strut and said board.

2. The fastening structure for a scooter as recited in claim 1, wherein one of said pipes of said front strut has a round end.

3. The fastening structure for a scooter as recited in claim 1, wherein one end of said latch has a slanting surface.
